(19) United States
(12) Patent Application Publication
(10) Pub. No.: US 2016/0134942 A1
(43) Pub. Date: May 12, 2016

(54) MULTIMEDIA PLAYING SYSTEM, MULTIMEDIA FILE SHARING METHOD AND CONTROL METHOD THEREOF

(71) Applicant: ALi Corporation, Hsinchu (TW)

(72) Inventor: Chun-Pin Lo, Hsinchu (TW)

(21) Appl. No.: 14/674,880

(22) Filed: Mar. 31, 2015

(30) Foreign Application Priority Data
Nov. 10, 2014 (CN) 201410628344.7

(51) Int. Cl. H04N 21/482; H04N 21/27

(52) U.S. Cl. CPC H04N 21/4825; H04N 21/27

(57) ABSTRACT

A multimedia playing system, a multimedia file sharing method and a control method are provided. The multimedia playing system includes multimedia playing devices, a server device and a user device. The server device detects the multimedia playing devices in a peripheral geographic area through the first communication standard, and communicates with the user device through a second communication standard. The server device displays the detected multimedia playing devices, a multimedia playlist and one of a multimedia file and a remote control function or a combination thereof obtained from the user device, and takes the user device as a remote controller of the server device, so as to play or execute one of the multimedia file listed in the multimedia playlist and the remote control function through the detected multimedia playing devices.

### CROSS-REFERENCE TO RELATED APPLICATION

This application claims the priority benefit of China application serial no. 201410628344.7, filed on Nov. 10, 2014. The entirety of the above-mentioned patent application is hereby incorporated by reference herein and made a part of this specification.

### BACKGROUND

1. Technical Field

The invention relates to a multimedia file sharing technique, and particularly relates to a multimedia playing system, a multimedia file sharing method and a control method for a multimedia device.

2. Related Art

A digital living network alliance (DLNA) standard is an industrial standard allowing digital devices in a digital home or a local area network to play, share or print multimedia format files. The DLNA standard can be constructed based on a universal plug and play (UPnP) technique, and integrates digital multimedia content to easily share multimedia files such as pictures, music, movies, playlist, etc.

In the DLNA standard, devices applying the DLNA standard include digital media server (DMS), digital media player (DMP), digital medial controller (DMC) and digital media render (DMR). The DMS can send a description file of a multimedia file to the other DMP, DMC or DMR, such that these devices can access, transmit and play the multimedia file to each other. For example, a user can use a computer, a mobile phone, a server, a player, etc. that is complied with the DLNA standard in a home network to share and play multimedia content (including movies, music, pictures, etc.).

However, although the DLNA standard provides possibility of transmitting and playing multimedia files between devices on a technical level, since setting steps of the related devices complied with the DLNA standard are complicated and not intuitive in actual applications, it is inconvenient in usage. In other words, when the user wants to transmit a multimedia file of a first device to a second device through the DLNA standard for playing, the user has to perform following operations step-by-step, i.e. select a source (for example, select the “first device”) of the multimedia file, select a folder location of the multimedia file, select the nearby second device complied with the DLNA standard, make the first device and the second device to communicate with each other, and then implement playing the multimedia file. Therefore, how to use an intuitive interface and an automation technique to make the related devices complied with the DLNA standard to be more close to consumer's usage habits in actual applications is always an important issue studied by manufacturers.

### SUMMARY

The invention is directed to a multimedia playing system, through which a plurality of devices in a peripheral geographic area are capable of intuitively and easily sharing and playing a multimedia file, so as to reduce operation steps in sharing and playing of the multimedia file.

The invention is directed to a multimedia file sharing method, by which a user device is capable of easily sharing a multimedia file through an intuitive man-machine interface, so as to reduce operation steps in sharing and playing of the multimedia file.

The invention is directed to a control method for multimedia device, by which a server device provides an easy and intuitive operation mode, such that the multimedia device and a user device that have different communication protocols are capable of conveniently sharing a multimedia file.

The invention provides a multimedia playing system including at least one multimedia playing device, a server device and a user device. The multimedia playing device is complied with a first communication standard. The server device detects the multimedia playing devices in a peripheral geographic area through the first communication standard. The user device communicates with the server device through a second communication standard. After the user device communicates with the server device, the server device displays the detected multimedia playing devices, a multimedia playlist and one of a multimedia file and a remote control function or a combination thereof obtained from the user device, and takes the user device as a remote controller of the server device, so as to play or execute one of the multimedia file listed in the multimedia playlist and the remote control function through the detected multimedia playing devices.

In an embodiment of the invention, each row of the multimedia playlist includes one of a path of the multimedia file and a function instruction for the multimedia playing devices or a combination thereof. The user device further includes a touch sensing module. When the user device serves as the remote controller of the server device, the touch sensing module detects a drag and drop operation and transmits a detection result to the server device through the second communication standard, such that one of each row of the multimedia playlist is dragged to the selected multimedia playing device according to the drag and drop operation. Therefore, the multimedia playing device selected by the drag and drop operation by using the user device as the remote controller plays or executes one of the multimedia file in the multimedia playlist and the remote control function.

In an embodiment of the invention, the multimedia playing system further includes a display module. The display module is configured to display the multimedia playing devices detected by the server device and the multimedia playlist obtained from the user device.

In an embodiment of the invention, the first communication standard is a digital living network alliance (DLNA) standard, and the second communication standard is one of a wireless fidelity (WiFi) standard, a WiFi direct standard, a bluetooth standard and a near field communication (NFC) standard or a combination thereof.

In an embodiment of the invention, the multimedia playing system further includes a camera module. The camera module is configured to capture a user image of a user for transmitting to the server device. The server device identifies an identification of the user according to the user image. The server device displays a personal interface corresponding to the user or the multimedia playlist according to the identification of the user.

In an embodiment of the invention, the server device applies an augmented reality technique to display the personal interface.

According to another aspect, the invention provides a multimedia file sharing method, which is adapted to a user device. The method includes following steps. The user device communicates with server device through a second communication standard, where the serve device detects multimedia playing devices in a peripheral geographic area through a first communication standard. A multimedia playlist and a multimedia file are transmitted to the server device through the second communication standard when communicating with the server device. The multimedia files listed in the multimedia playlist is played on the detected multimedia playing devices under control of the server device through the first communication standard.

In an embodiment of the invention, the user device further includes a touch display device. The touch display device displays the multimedia playlist and detects a drag and drop operation, and a path of the multimedia file of the multimedia playlist is dragged to one of the multimedia playing devices according to the drag and drop operation. The multimedia file corresponding to the multimedia file path is played in the multimedia playing device.

In an embodiment of the invention, the first communication standard is a digital living network alliance (DLNA) standard, and the second communication standard is one of a wireless Fidelity (WiFi) standard, a WiFi direct standard, a bluetooth standard and a near field communication (NFC) standard or a combination thereof

In an embodiment of the invention, the multimedia file sharing method further includes following steps. A user image of the user is captured and an identification of the user is identified according to the user image. Moreover, a personal interface corresponding to the user or the multimedia playlist is displayed according to the identification of the user.

In an embodiment of the invention, the multimedia file sharing method further includes using an augmented reality technique to display the personal interface.

According to another aspect, the invention provides a control method for multimedia device. The control method for multimedia device is adapted to a server device, and includes following steps. At least one multimedia playing device is detected in a peripheral geographic area through a first communication standard. The server device communicates with a user device through a second communication standard. A multimedia playlist and a multimedia file are received from the user device through the second communication standard when communicating with the user device. A drag and drop operation is received from the user device, so as to play the multimedia file listed in the multimedia playlist by the at least one multimedia playing device corresponding to the drag and drop operation through the first communication standard.

According to the above descriptions, the multimedia playing system, the multimedia file sharing method and the control method of the invention take the server device as a center hub for data transmission, so as to connect a plurality of multimedia playing devices with the user device, and the man-machine interface displayed in the server device is used to present the multimedia playing devices and the multimedia playlist in the user device. The user can use the user device that serves as the remote controller to select the multimedia file in the multimedia playlist on the server device and the multimedia playing device used for playing the multimedia file in a one-off mode through a drag and drop manner, such that the sharing function of multimedia content is more intuitive and easy to use. In this way, the user can use a simple and intuitive operation method to conveniently share multimedia files between a plurality of devices.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a multimedia playing system according to an embodiment of the invention.

FIG. 2 is a block diagram of a user device and a server device according to an embodiment of the invention.

FIG. 3 is a flowchart illustrating a multimedia file sharing method according to an embodiment of the invention.

FIG. 4 is a schematic diagram of a display image of the server device according to an embodiment of the invention.

FIG. 5 is a schematic diagram of a multimedia file sharing method according to an embodiment of the invention.

FIG. 6 is a schematic diagram of playing a multimedia file according to an embodiment of the invention.

FIG. 7 is a flowchart illustrating a control method for multimedia device according to an embodiment of the invention.

### DETAILED DESCRIPTION OF DISCLOSED EMBODIMENTS

In the invention, a multimedia playing system, a multimedia file sharing method and a control method for multimedia device disclosed in following embodiments are designed based on a digital living network alliance (DLNA) standard. In the embodiments of the invention, a server device is taken as a center hub for data transmission, so as to implement mutual communication between a plurality of multimedia playing devices and a user device. After the server device communicates with the user device, the server device can display an image of a man-machine interface, and the image presents icons representing the multimedia playing devices and a multimedia playlist obtained from the user device. By using the user device as a remote controller of the server device, the user can select the multimedia file to be played and the multimedia playing device used for playing the multimedia file in a one-off mode through a drag and drop manner, such that the sharing function of multimedia content is more intuitive and easy to use. In this way, the user can use a simple and intuitive operation method to conveniently share multimedia files between a plurality of devices. Details of the embodiments of the invention are described below.

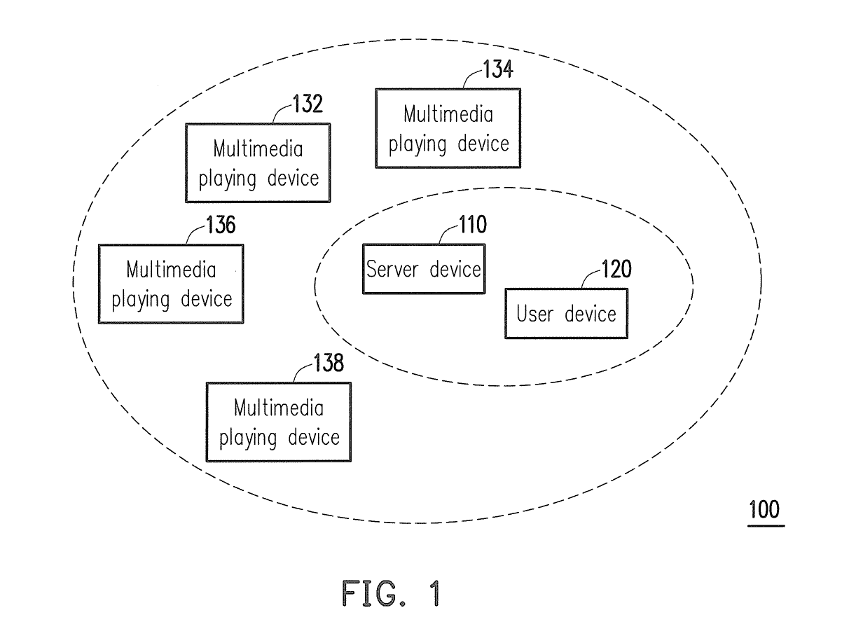

FIG. 1 is a schematic diagram of a multimedia playing system according to an embodiment of the invention. Referring to FIG. 1, the multimedia playing system 100 of the present embodiment includes a server device 110, a user device 120, a multimedia playing device 132, a multimedia playing device 134, a multimedia playing device 136 and a multimedia playing device 138.

The server device 110 is, for example, a set-up box, a computer, a server, etc., which is not limited by the invention. The server device 110 detects a plurality of the multimedia playing devices 132, 134, 136 and 138 in a peripheral geographic area through a first communication standard, for example, a digital home communication standard specified by digital living network alliance (DLNA).

The user device 120 is, for example, a smart phone, a tablet PC, etc., though the invention is not limited thereto, and the present embodiment can also be implemented in other consumable electronic products. The user device 120 communicates with the server device 110 through a second communication standard, for example, one of a wireless fidelity (WiFi) standard, a WiFi direct standard, a Bluetooth standard, and a near field communication (NFC) standard or a combination thereof. However, the invention is not limited thereto. In an embodiment, the user device 120 includes a touch sensing module (for example, a touchpad), and through the touch sensing module, the user device 120 can serve as a remote controller of the server device 110. In another embodiment, the user device 120 includes a touch display device, for example, touch screen, and the touch screen can serve as the remote controller of the server device 110.

The multimedia playing devices 132, 134, 136 and 138 may be respectively a computer, a server, a video cassette recorder (VCR), a digital camera, a player, an audio system, a smart phone, or a tablet PC, etc., though the invention is not limited thereto, and those skilled in the art can implement the functions of the multimedia playing devices in other electronic products. In the present embodiment, the multimedia playing devices are complied with the first communication standard, and the first communication standard is, for example, the digital home communication standard specified by the DLNA.

In an embodiment, the multimedia playing system 100 includes a display module, and the display module is, for example, a screen coupled to the server device 110, or an electronic device having a screen and using a communication standard the same with that of the multimedia playing devices, for example, a television, which is not limited by the invention. Since the user always sets multimedia devices such as a digital television and a set-up box, etc. at a home center, in the present embodiment, the digital television can serve as the server device 110, such that the digital television or the set-up box can serve as a center hub for data transmission.

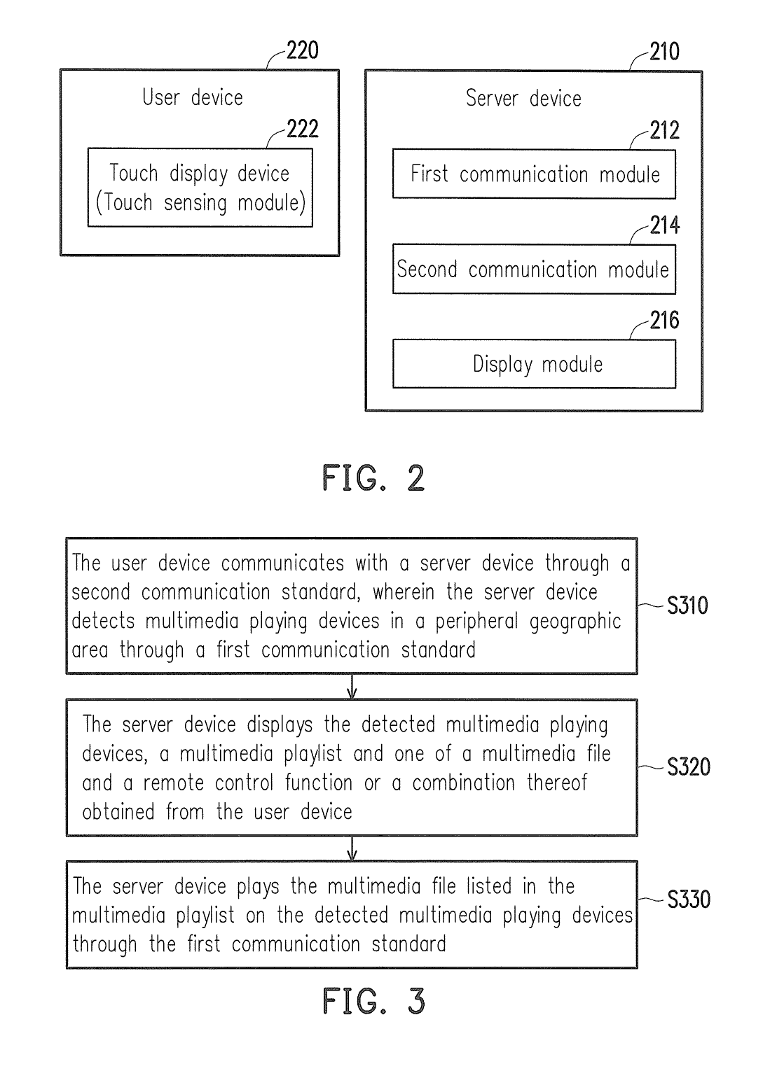

FIG. 2 is a block diagram of a user device and a server device according to an embodiment of the invention. Referring to FIG. 2, the server device 210 includes a first communication module 212, a second communication module 214 and a display module 216. The first communication module 212 is complied with the first communication standard, for example, the digital home communication standard specified by the DLNA for communicating with the multimedia playing devices. The second communication module 214 is complied with the second communication standard, for example, one of the WiFi standard, the WiFi direct standard, the Bluetooth standard and the NFC standard or a combination thereof for communicating with the user device 220. The display module 216 is, for example, a screen set on the server device 210, which is not limited by the invention. The user device 220 includes a touch display device 222, which serves as a remote controller of the server device 210.

FIG. 3 is a flowchart illustrating a multimedia file sharing method according to an embodiment of the invention. Referring to FIG. 2 and FIG. 3, in step S310, the server device 210 communicates with the user device 220 through the second communication standard, for example, the NFC standard via the second communication module 214. The NFC is a short-range high-frequency wireless communication technique, which is adapted to a short-range communication within an effective distance of 20 cm. Therefore, when the user device 220 enters a near field communication range of the server device 210, the two devices automatically establish a connection. Meanwhile, through the first communication standard, for example, the DLNA, the server device 210 detects a plurality of the multimedia playing devices 132, 134, 136 and 138 complied with the first communication standard in a peripheral geographic area through the first communication module 212, and establishes connections therewith.

Then, in step S320, the display module 216 of the server device 210 displays representations of the detected multimedia playing devices 132, 134, 136 and 138, for example, characters, icons or symbols used for distinguishing the multimedia playing devices, and a multimedia playlist and one of a multimedia file and a remote control function or a combination thereof obtained from the user device 220. The multimedia playlist is, for example, a favourite video playlist of the user, which includes a plurality of rows, where each of the rows includes information such as a file name, a source path, a representative icon, etc. of the multimedia file, which is not limited by the invention. The multimedia file includes a video and audio files of different types that has a video format complied with, for example, moving pictures experts group standards (MPEG) audio video interleave (AVI), joint photographic experts group (JPEG), bitmap (BMP), or an audio format complied with, for example, motion picture experts group audio layer 3 (MP3), windows media audio (WMA), etc., though the invention is not limited thereto. The remote control function is, for example, functions of playing multimedia file, stop, fast-forward, fast-backward, next, or volume adjustment, etc., which is not limited by the invention.

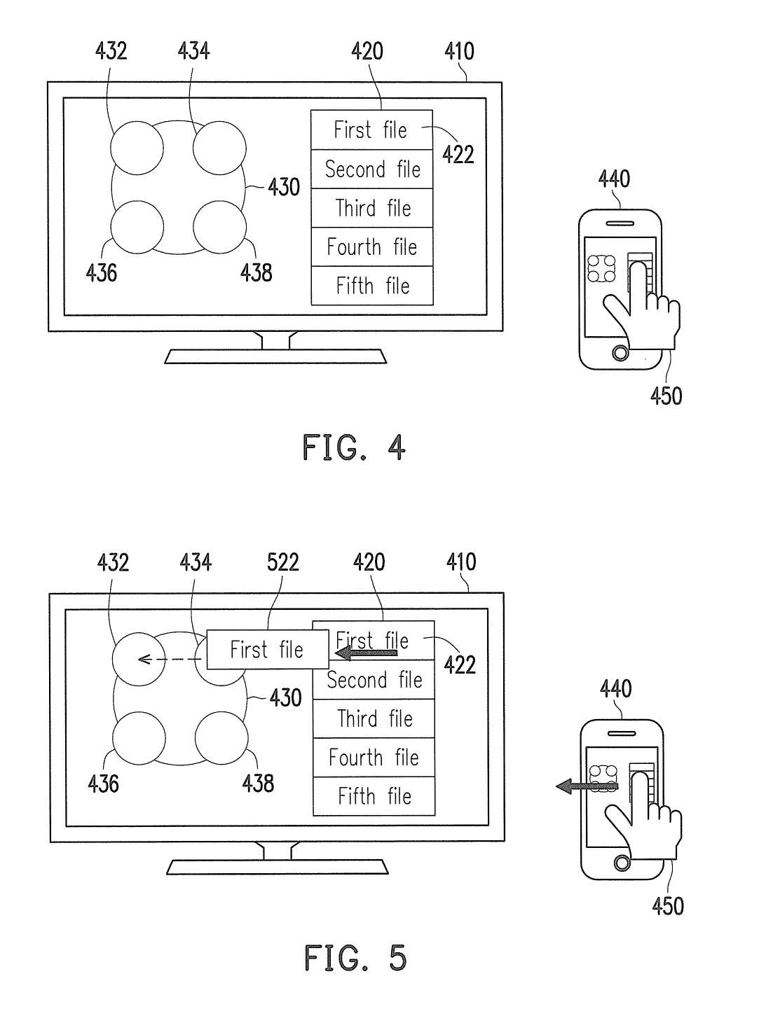

For example, FIG. 4 is a schematic diagram of a display image of the server device according to an embodiment of the invention. In FIG. 4, a television 410 used as the display module of the server device 210, a multimedia playlist 420, a multimedia playing device icon 430, a user device 440 and a user 450 are illustrated. It should be noticed that the display image of the server device 210 of FIG. 4 is an exemplary man-machine interface configuration, and the invention is not limited thereto. In detail, the server device 210 obtains the multimedia playlist 420 from the user device 440, and displays the multimedia playlist 420 by using the television 410. Each row of the multimedia playlist 420 includes an icon and a multimedia file name. In an embodiment, each row of the multimedia playlist 420 includes one of a path of the multimedia file and a function instruction for the multimedia playing devices or a combination thereof. Meanwhile, after the server devices 210 detects the multimedia playing devices 132, 134, 136 and 138 complied with the DLNA standard, the television 410 displays the multimedia playing device icon 430. To be specific, the multimedia playing device icon 430 includes multimedia playing device icons 432, 434, 436 and 438 respectively corresponding to the multimedia playing devices 132, 134, 136 and 138.

In step S330 of FIG. 3, the server device 210 plays the multimedia files listed in the multimedia playlist on the detected multimedia playing devices 132, 134, 136 and 138 through the DLNA via the first communication module 212.

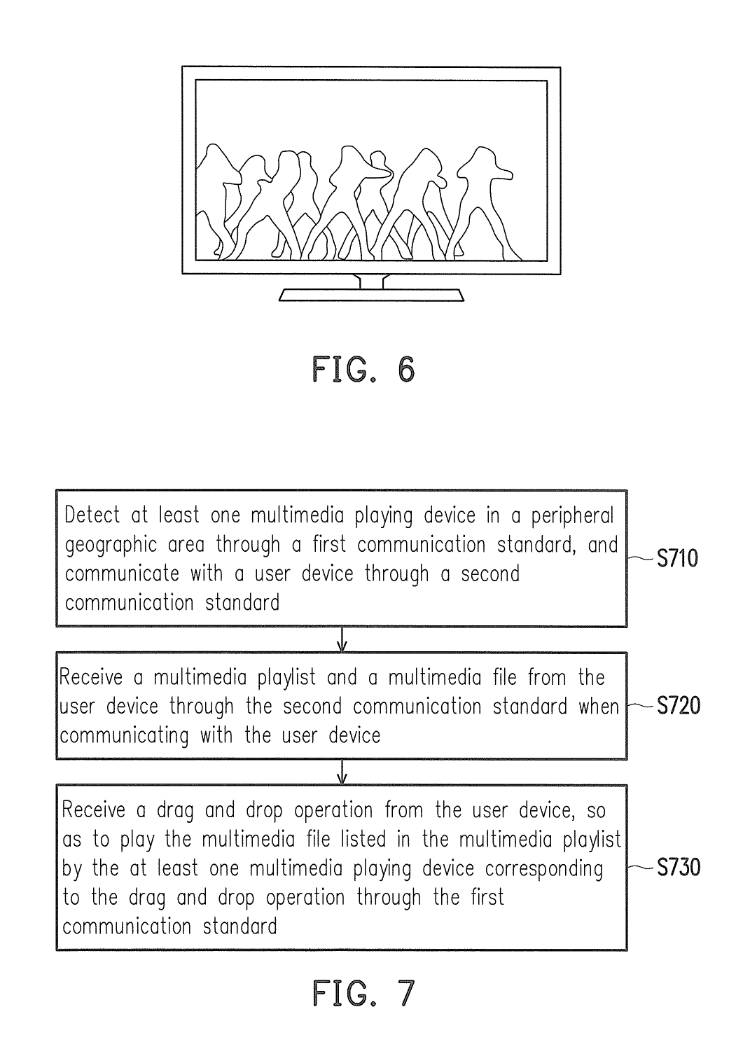

For example, FIG. 5 is a schematic diagram of a multimedia file sharing method according to an embodiment of the invention. FIG. 6 is a schematic diagram of playing a multimedia file according to an embodiment of the invention. In FIG. 5, the television 410 used as the display module of the server device 210, the multimedia playlist 420, the multimedia playing device icon 430, the user device 440 and the user 450 are illustrated. Referring to FIG. 5, when the user 450 wants to use the multimedia playing device 132 to play a multimedia file 422, the user takes the user device 440 as the remote controller of the server device 110, and selects the multimedia file 422 in the multimedia playlist 420 through a drag and drop manner, and drags an icon 522 representing the multimedia file 422 to a multimedia playing device icon 432 representing the multimedia playing device 132. Then, referring to FIG. 6, after the server device 210 receives an instruction of the drag and drop operation, the serve device 210 transmits the multimedia file 422 to the multimedia playing device 132 according to a source path of the multimedia file 422, and controls the multimedia playing device 132 to play the multimedia file 422. It should be noticed that when the user device 440 serves as the remote controller of the server device 210, the touch sensing module of the user device 440 can serve as a touchpad. Moreover, the touch display device of the user device 440 displays a display image corresponding to the man-machine interface of the server device 210, or is used as a touchpad in a non-image mode, which is not limited by the invention.

Moreover, the multimedia playing system 100 further includes a camera module, which is used for capturing a user image of the user for transmitting to the server device 210, and the server device 210 identifies an identification of the user according to the user image. The server device 210 controls the display module 216 to display a personal interface corresponding to the user or the multimedia playlist according to the identification of the user. Moreover, in an embodiment, an augmented reality technique is used to display the personal interface corresponding to the user.

FIG. 7 is a flowchart illustrating a control method for multimedia device according to an embodiment of the invention. Referring to FIG. 1 and FIG. 7, in step S710, the server device 110 detects the multimedia playing devices 132, 134, 136 and 138 in the peripheral geographic area through, for example, the DLNA, and communicates with the user device 120 through, for example, the NFC standard. Then, in step S720, when the server device 110 and the user device 120 are close enough and to automatically connect with each other for communication, the server device 110 receives the multimedia playlist and the multimedia file from the user device 120. Finally, in step S730, the server device 110 receives a drag and drop operation from the user device 120 serving as the remote controller of the server device 110. Through the DLNA, the server device 110 transmits the multimedia file selected by the user from the multimedia files listed in the multimedia playlist through the drag and drop operation to one of the multimedia playing devices 132, 134, 136 and 138 corresponding to the multimedia playing device icon in the drag and drop operation for playing. Based on the intuitive man-machine interface operation, the user device can conveniently share the multimedia files to the multimedia playing devices through the server device. According to the embodiment of the invention, the user can connect the user device 120 and the server device 110 in advance, and then the user can control the remote peripheral multimedia playing devices to play the multimedia file or execute the remote control function through the server device 110. In this way, a communication distance of the user device 120 can be extended to the remote peripheral multimedia playing devices through the server device 110.

In summary, the multimedia playing system of the invention takes the server device as a center hub for data transmission, so as to connect a plurality of multimedia playing devices with the user device, and the man-machine interface displayed in the server device is used to present the multimedia playing devices and the multimedia playlist in the user device. The user can use the user device that serves as the remote controller to select the multimedia file in the multimedia playlist on the server device and the multimedia playing device used for playing the multimedia file in a one-off mode through a drag and drop manner, such that the sharing function of multimedia content is more intuitive and easy to use. Moreover, a customized user interface can be provided by identifying the identification of the user, and an augmented reality technique is used to present the personal interface. In this way, the user can quickly and intuitively share the multimedia files.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A multimedia playing system, comprising:
at least one multimedia playing device, complied with a first communication standard;
a server device, detecting the multimedia playing devices in a peripheral geographic area through the first communication standard; and
a user device, communicating with the server device through a second communication standard,
wherein after the user device communicates with the server device, the server device displays the detected multimedia playing devices, a multimedia playlist and one of a multimedia file and a remote control function or a combination thereof obtained from the user device, and takes the user device as a remote controller of the server device, so as to play or execute one of the multimedia file listed in the multimedia playlist and the remote control function through the detected multimedia playing devices.

2. The multimedia playing system as claimed in claim 1, wherein each row of the multimedia playlist comprises one of a path of the multimedia file and a function instruction for the multimedia playing devices or a combination thereof, and
the user device further comprises a touch sensing module, and when the user device serves as the remote controller of the server device, the touch sensing module detects a drag and drop operation and transmits a detection result to the server device through the second communication standard, such that one of each row of the displayed multimedia playlist is dragged to the selected multimedia playing device according to the drag and drop operation, and the selected multimedia playing device plays or executes one of the multimedia file in the multimedia playlist and the remote control function.

3. The multimedia playing system as claimed in claim 1, further comprising:
a display module, configured to display the multimedia playing devices detected by the server device and the multimedia playlist obtained from the user device.

4. The multimedia playing system as claimed in claim 1, wherein the first communication standard is a digital living network alliance (DLNA) standard, and the second communication standard is one of a wireless fidelity (WiFi) standard, a WiFi direct standard, a bluetooth standard and a near field communication (NFC) standard or a combination thereof.

5. The multimedia playing system as claimed in claim 1, further comprising:
a camera module, configured to capture a user image of a user for transmitting to the server device, wherein the server device identifies an identification of the user according to the user image, and
the server device displays a personal interface corresponding to the user or the multimedia playlist according to the identification of the user.

6. The multimedia playing system as claimed in claim 5, wherein the server device applies an augmented reality technique to display the personal interface.

7. A multimedia file sharing method, adapted to a user device, the multimedia file sharing method comprising:
communicating with a server device through a second communication standard, wherein the server device detects at least one multimedia playing device in a peripheral geographic area through a first communication standard;
transmitting a multimedia playlist and a multimedia file to the server device through the second communication standard when communicating with the server device; and
playing the multimedia file listed in the multimedia playlist on the detected multimedia playing devices under control of the server device through the first communication standard.

8. The multimedia file sharing method as claimed in claim 7, wherein the user device further comprises a touch display device,
and the multimedia file sharing method further comprises:
displaying the multimedia playlist and detecting a drag and drop operation by the touch display device, wherein a path of the multimedia file of the multimedia playlist is dragged to one of the multimedia playing devices according to the drag and drop operation, and the multimedia file corresponding to the path of the multimedia file is played in the multimedia playing device.

9. The multimedia file sharing method as claimed in claim 7, wherein the first communication standard is a digital living network alliance (DLNA) standard, and the second communication standard is one of a wireless Fidelity (WiFi) standard, a WiFi direct standard, a bluetooth standard and a near field communication (NFC) standard or a combination thereof.

10. The multimedia file sharing method as claimed in claim 7, further comprising:
capturing a user image of a user and identifying an identification of the user according to the user image; and
displaying a personal interface corresponding to the user or the multimedia playlist according to the identification of the user.

11. The multimedia file sharing method as claimed in claim 10, further comprising using an augmented reality technique to display the personal interface.

12. A control method for multimedia device, adapted to a server device, the control method comprising:
detecting at least one multimedia playing device in a peripheral geographic area through a first communication standard;
communicating with a user device through a second communication standard;
receiving a multimedia playlist and a multimedia file from the user device through the second communication standard when communicating with the user device; and
receiving a drag and drop operation from the user device, so as to play the multimedia file listed in the multimedia playlist by the at least one multimedia playing device corresponding to the drag and drop operation through the first communication standard.
